(19) United States
(12) Patent Application Publication
(10) Pub. No.: US 2010/0327081 A1
(43) Pub. Date: Dec. 30, 2010

(54) LOW PRESSURE AIR-BLAST ATOMIZER

(76) Inventor: Jerry L. Martin, Superior, CO (US)

Correspondence Address: Law Office of Daniel W. Roberts, 904 Topaz Street, Superior, CO, 80027, US

(21) Appl. No.: 12/491,745

(22) Filed: Jun. 25, 2009

(51) Int. Cl. B05B 7/10; B05B 17/04

(52) U.S. Cl. 239/403; 239/432

(57) ABSTRACT

This invention provides a low pressure air-blast atomizer. The atomizer includes a primary body having an inlet side, a discharge end and an axis therebetween. A first gas passage disposed about the axis. A substantially circumferential liquid passage is disposed adjacent to the first gas passage and proximate to the inlet side. An annular metering insert is disposed between the circumferential liquid passage and the first gas passage, the metering insert providing substantially circumferential fluid communication between the circumferential liquid passage and the first gas passage. A liquid inlet passageway extends from the circumferential liquid passage to an external liquid port. A secondary body is structured and arranged to receive the discharge end of the primary body, the secondary body and discharge end defining a plurality of swirling passageways circumferentially about the first gas passage and terminating proximate to a discharge end of the first gas passage. A plurality of secondary gas passages extend from the swirling passageways to external ports proximate to the inlet side.

### FIELD OF THE INVENTION

This invention relates generally to the field of liquid atomization, and more specifically to an air-blast atomizer device used to atomize liquids at low pressure.

### BACKGROUND OF THE INVENTION

An atomizer is a device that converts a stream of liquid into a fine spray. Atomizers are found in a wide variety of industries, such as perfume, paint, combustion, printing, or other fields where a fine spray of a liquid is desired.

In many instances the atomizer is driven by air pressure provided by a compressor or, in the case of a combustion or turbine engine, by the pressure generated by the engine itself. An operating pressure of 10 psi (7 kPa) or more is quite normal, however in many instances this pressure is far in excess of that which can be easily obtained and/or maintained.

In other instances, the liquid being supplied for atomization is pressurized so as to be sprayed or jetted into an gas stream. The need for the liquid to be pressurized may again impose limitations on use.

Various attempts have been made at providing low pressure atomizers. Typically these devices have relied upon small passages that are prone to clogging. See for example U.S. Pat. No. 6,578,777 and U.S. Pat. No. 6,729,562 to Bui each relying on a metering orifice in a metering insert and the use of an impact wall to reduce fluid velocity.

Spraying the liquid across free space into an air stream has also been demonstrated. However, as the liquid must be sprayed, there are minimal clearances between the spray aperture and the receiving surface so as to permit droplets to form. Such apertures are also prone to clogging. See also U.S. Pat. No. 5,921,470 to Kamath wherein oil supplied at a pressure of about 3 psi to 10 psi is sprayed from an aperture at 90 degrees to the flow of the primary air.

In yet other airblast atomizers, the fuel is provided directly to the discharge tip, again through small passages, into a swirling vortex of air, the atomization process occurring without prefilming, see for example U.S. Pat. No. 5,086,979 to Koblish et al. These devices typically require high air pressures to obtain small droplets.

The small passages, jetting properties and overall complex arrangement of components make many atomizers difficult to manufacture, prone to clogging and make cleaning and repair a less than easy process. In addition, the physical size of the components and inherent physics, e.g. free space for droplet jetting, limit the size of the atomizer. These limitations, including that of size, can be problematic when desiring an atomizer for portable applications where a low flow of liquid is required.

Hence, there is a need for a low pressure air-blast atomizer that overcomes one or more of the drawbacks identified above. The present invention satisfies one or more of these needs.

### SUMMARY

This invention provides a low pressure air-blast atomizer.

In particular, and by way of example only, according to an embodiment of the present invention, this invention provides a low pressure air-blast atomizer, including: a primary body having an inlet side, a discharge end and an axis therebetween; an annular prefilmer disposed about the axis; a substantially annular liquid reservoir about the annular prefilmer and proximate to the inlet side; a liquid passageway structured and arranged to provide liquid from an external source to the liquid reservoir; a liquid meterer structured and arranged to circumferentially meter liquid from the liquid reservoir to the annular prefilmer; a secondary body structured and arranged to receive the discharge end, the secondary body and discharge end defining a swirling chamber about at least a portion of the annular prefilmer, the swirling chamber opening proximate to the discharge end; and a plurality of secondary gas passages extending from the swirling chamber to external ports proximate to the inlet side.

Moreover, according to an embodiment thereof, the invention may provide a low pressure air-blast atomizer, including: a primary body having an inlet side, a discharge end and an axis therebetween; a first gas passage disposed about the axis; a substantially circumferential liquid passage adjacent to the first gas passage and proximate to the inlet side; an annular metering insert disposed between the circumferential liquid passage and the first gas passage, the metering insert providing substantially circumferential fluid communication between the circumferential liquid passage and the first gas passage; a liquid inlet passageway extending from the circumferential liquid passage to an external liquid port; a secondary body structured and arranged to receive the discharge end, the secondary body and discharge end defining a plurality of swirling passageways circumferentially about the first gas passage and terminating proximate to a discharge end of the first gas passage; and a plurality of secondary gas passages extending from the swirling passageways to external ports proximate to the inlet side.

In yet another embodiment, the invention may provide a low pressure air-blast atomizer, including: a primary body having; an inlet side; a tapered discharge end and an axis therebetween; a primary gas passage disposed about the axis; a plurality of secondary gas passages about and apart from the primary gas passage in the inlet end; a substantially annular channel proximate to the primary gas passage and adjacent to the inlet end; a liquid passage adjoining the substantially annular channel to an external liquid port disposed in the inlet end; and an annular metering insert disposed in the primary gas passage adjacent to the substantially annular channel, the annular metering insert providing substantially circumferential fluid communication between the substantially annular channel and the primary gas passage; a secondary body structured and arranged to receive the tapered discharge end; at least one swirling structure disposed between the secondary body and the tapered discharge end to define a swirling chamber, the swirling chamber having an input section in communication with the secondary gas passages and an output section adjacent to a discharge end of the primary gas passage.

These and other objects, features and advantages of the preferred method and apparatus will become apparent from the following detailed description, taken in conjunction with the accompanying drawings which illustrate, by way of example the principles of the invention.

### BRIEF DESCRIPTION OF THE DRAWINGS

FIG. 1 is a perspective view a low pressure air-blast atomizer in accordance with at least one embodiment;

FIG. 2 is a perspective cut through of the low pressure air-blast atomizer as shown in FIG. 1;

FIG. 3 is an alternative perspective cut through of the low pressure air-blast atomizer as shown in FIG. 1;

FIG. 4 illustrates alternative embodiments for the annular metering insert of the low pressure air-blast atomizer;

FIGS. 5 and 6 are exploded perspective views of the low pressure air-blast atomizer in accordance with at least one embodiment;

FIG. 7 is a cut through of a low pressure air-blast atomizer according to yet another alternative embodiment;

FIGS. 8 and 9 are exploded perspective views of the low pressure air-blast atomizer shown in FIG. 7;

FIG. 10 is a cut through of a low pressure air-blast atomizer according to still yet another alternative embodiment;

FIGS. 11 and 12 are exploded perspective views of the low pressure air-blast atomizer shown in FIG. 10;

FIG. 13 is a cut through of the low pressure air-blast atomizer shown in FIG. 1 further illustrating the atomization of a liquid;

FIG. 14 is a graph showing droplet size dispersion as provided by a low pressure air-blast atomizer in accordance with at least one embodiment;

FIG. 15 is a graph showing distribution vs. feed pressure and Dv(s) vs. Pressure as provided low pressure air-blast atomizer in accordance with at least one embodiment; and

FIG. 16 is a cut through of still another low pressure air-blast atomizer according to an alternative embodiment.

### DETAILED DESCRIPTION

Before proceeding with the detailed description, it is to be appreciated that the present teaching is by way of example only, not by limitation. The concepts herein are not limited to use or application with a specific system or method for a low pressure air-blast atomizer. Thus, although the instrumentalities described herein are, for the convenience of explanation, shown and described with respect to exemplary embodiments, it will be appreciated that the principles herein may be applied equally in other types of systems and methods involving low pressure air-blast atomizers.

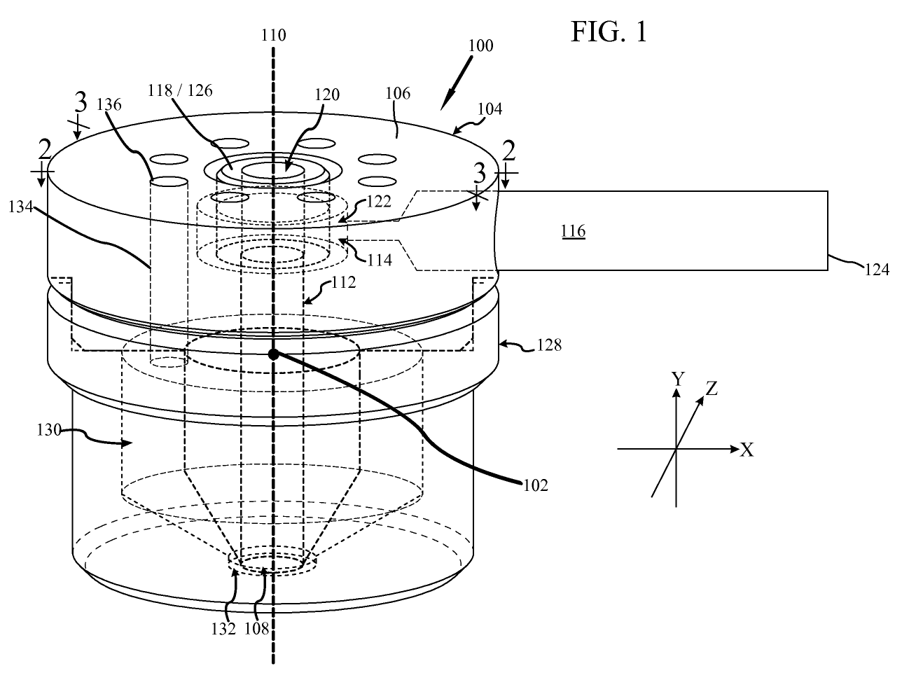

Referring now to the drawings wherein like reference numbers identify similar elements, and more specifically FIGS. 1-13 and 16, there is shown a low pressure air-blast atomizer (herinafter “atomizer”) 100 according to at least one embedment. To facilitate the description of atomizer 100, the orientations of atomizer 100 as presented in the figures are referenced to the coordinate system with three axes orthogonal to one another, as shown initially in FIG. 1.

The axes intersect mutually at the origin of the coordinate system, which is chosen to locate at the center 102 of atomizer 100. The axes shown in all figures are offset from their actual locations, for clarity. Moreover, FIG. 1 is a slight perspective view defined by the X-axis, Y-axis and Z-axis.

Atomizer 100 is a pre-filming air blast atomizer capable of operating at very low air feed pressure. In one common application, air and fuel are provided to the atomizer 100 and directed through the atomizer 100 in such an advantageous manner as to provide an output of atomized fuel and air mixture. Although commonly referred to as an air blast atomizer, it is understood and appreciated that atomizer 100 is not limited to the use of air as the atomizing gas and fuel as the atomized liquid. Rather, as atomization of various combinations of liquids and gases may be desirable for a variety of different purposes, the discussion of atomizer 100 presented herein is with respect to atomization involving any gas and any liquid. It is also further understood and appreciated that a gas may include vaporized fluids, such as for example steam. Similarly, a liquid may be a combination of various liquids.

Shown in FIG. 1, in accordance with at least one embodiment, the atomizer 100 has a primary body 104 having an inlet side 106, a discharge end 108 and an axis 110. In at least one embodiment axis 110 is a central axis.

An annular prefilmer 112 is disposed about the axis 110. As is further described below the annular prefilmer prefilms a liquid as the liquid moves towards the discharge end 108. A substantially annular liquid reservoir 114 is provided about the annular prefilmer 112. A liquid passageway 116 is structured and arranged to provide liquid from an external source (not shown) to the substantially annular liquid reservoir 114. A liquid meterer 118 is structured and arranged to circumferentially meter liquid from the substantially annular liquid reservoir 114 to the annular prefilmer 112.

In at least one embodiment the prefilmer 112 is provided by a first gas passage 120 disposed about the axis. In addition, in at least one embodiment the substantially annular liquid reservoir 114 is a substantially circumferential liquid passage 122, adjacent to the first gas passage 120 and proximate to the inlet side 106. The liquid inlet passageway 116 extends from the substantially circumferential liquid passage 122 to an external liquid port 124.

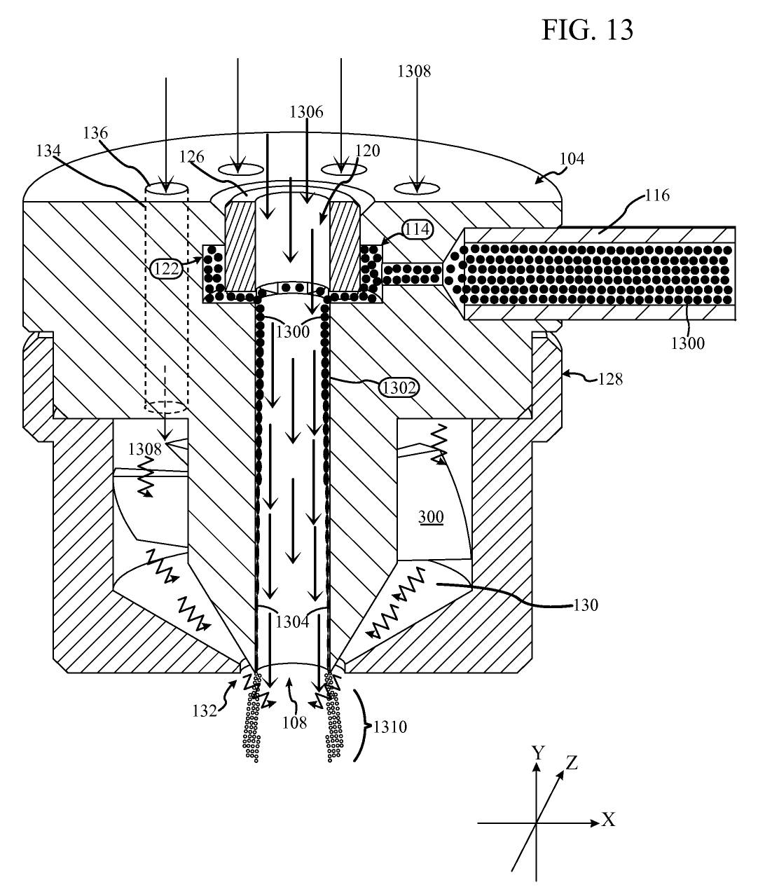

As the axis 110 may be a central axis, the first gas passage 120 is in at least one embodiment a central gas passage. In addition, the first gas passage passes directly through the primary body 104. Such direct passage may simplify fabrication as complex turns and passageways are avoided. In further addition, the direct passage provides a greater surface length upon which the prefilming of the liquid will occur as is described below (see FIG. 13). Moreover, in at least one embodiment, the first gas passage 120 is provided as a bore throughout the primary body 104.

According to at least one embodiment, the liquid meterer 118 is an annular metering insert 126 disposed between the substantially circumferential liquid passage 122 and the first gas passage 120 proximate to the inlet side 106. A secondary body 128 receives the discharge end 108 and together therewith defines a swirling chamber 130 having an opening 132 proximate to the discharge end 108. A plurality of secondary gas passages 134 extend from external ports, of which port 136 is exemplary, proximate to the inlet side 106 to the swirling chamber 130.

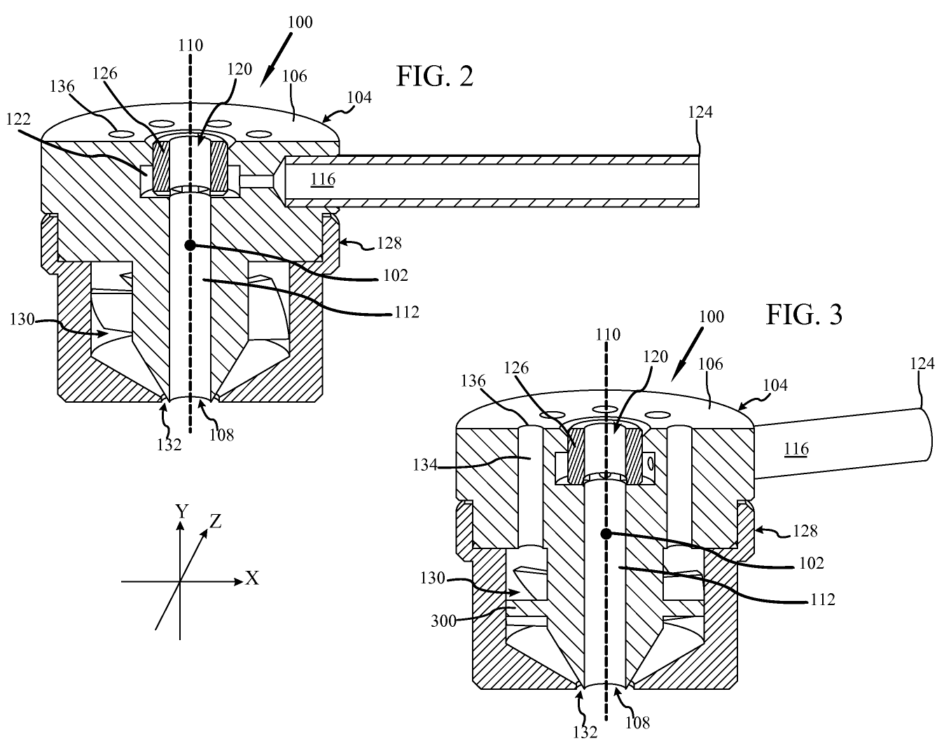

Although the dotted relief of FIG. 1 suggests elements otherwise at least partially concealed by the primary body 104 and secondary body 128, the cut through illustrations of FIGS. 2-3 are provided to further illustrate and clarify these elements.

More specifically, FIG. 2 is a cut through of atomizer 100 more clearly illustrating the relationship between the first gas passage 120, the substantially circumferential liquid passage 122, the annular metering insert 126, and the liquid inlet passageway 116.

Moreover, with respect to at least FIG. 2, it is appreciated that in accordance with at least one embodiment the primary body 104 has an inlet side 106 and a discharge end 108 an axis 110 therebetween. Further, in at least one embodiment, the discharge end 108 is a tapered discharge end. The first gas passage 120 is disposed about the axis 110. In at least one embodiment, the first gas passage 120 is a primary gas passage 120.

FIG. 3 is a cut through of atomizer 100 more clearly illustrating the relationship of the plurality of secondary gas passages 134, extending from the external ports 136 to the swirling chamber 130. More specifically, the plurality of secondary gas passages are disposed about and apart from the primary gas passage 120. For ease of illustration and discussion, secondary gas passages 134 have been shown as substantially parallel to primary gas passage 120. In at least one alternative embodiment secondary gas passages 134 are angled. Such angling may in certain embodiments enhance the swirling of the gas passing through secondary gas passages 134 and provided to the swirling chamber 130. In addition, although the secondary gas passages 134 are shown disposed within inlet side 106, in varying embodiments the ports 136 for secondary gas passages 134 are disposed in the side of primary body 104 proximate to the inlet side 106.

As is clearly shown in FIG. 3, in at least one embodiment, the swirling chamber 130 consists of at least one swirling structure. Moreover, in at least one embodiment the swirling structure is provided by a plurality of swirling passageways, e.g., angled passageways. Further still, in at least one embodiment the swirling passageways are defined by a plurality of vanes 300. In at least one embodiment, the vanes 300 extend radially outward from the tapered discharge end 108.

Returning to FIG. 2, the substantially circumferential liquid passage 122 is, in at least one embodiment, a substantially annular channel proximate to the first gas passageway 120. The substantially circumferential liquid passage 122 receives liquid from liquid inlet passageway 116. Liquid inlet passageway 116 is a liquid conduit that adjoins the substantially annular channel to an external liquid port disposed in or at least proximate to, the inlet side 106.

In at least one embodiment the substantially circumferential liquid passage 122 is a continuous circumferential structure. Indeed, in at least one embodiment, the circumferential liquid passage 122 is a continuous annular structure about the first gas passage. In alternative embodiments a plurality of liquid chambers disposed about the first gas passage 120 may be used, which collectively serve as substantially circumferential liquid passage 122. As is further described below, this circumferential liquid passage, whether a complete unitary circumferential liquid passage or a substantially circumferential liquid passage serves to provide a liquid reservoir from which liquid is provided to the wall of the first gas passage 120.

The annular metering insert 126 is disposed between the substantially circumferential liquid passage 122 and the first gas passage 120. The metering insert 126 provides substantially circumferential fluid communication between the substantially circumferential liquid passage 122 and the first gas passage 120. The annular metering insert 126 retards the flow of liquid from the liquid inlet passageway 116 to the first gas passage 120. Moreover, in accordance with at least one embodiment, the annular metering insert 126 permits substantially circumferential flow from the substantially circumferential liquid passage 122 to the first gas passage at a rate sufficient to provide a thin film of liquid upon the inner wall of the first gas passage 120. Indeed, liquid does not spray, stream, jet or otherwise squirt from the metering insert 126. Moreover, the liquid may be described as oozing through metering insert 126 to contact the inner wall of the first gas passage 120.

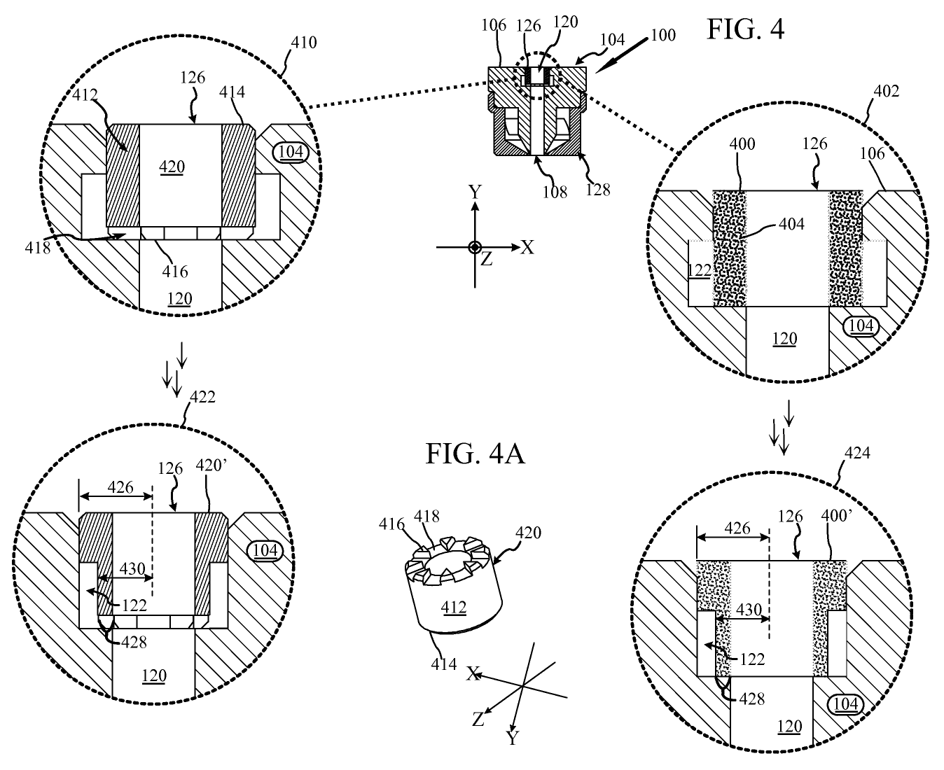

FIG. 4 presents a plane cross section view of the primary body 104, the secondary body 128, the first gas passage 120, and most specifically the annular metering insert 126. In at least one embodiment, the metering insert is a substantially annular porous insert 400 as shown in enlarged circle 402.

Substantially annular porous insert 400 is composed of particles 404 pressed together. In at least one embodiment, porous insert 400 is composed of a plurality of metallic particles pressed together. In at least on embodiment, porous insert 400 is composed of a plurality of glass and/or ceramic particles pressed or sintered together. In at least one additional alternative embodiment, substantially annular porous insert 400 is composed of a plurality of plastic particles pressed together. Moreover, in yet one further embodiment, substantially annular porous insert 400 is composed of various particles selected from metal, glass, ceramic, plastic and combinations thereof. As the particles are pressed together, providing a plurality of passageways, fluid communication from the substantially circumferential liquid passage 122 to the first gas passage 120 is indeed substantially circumferential.

An alternative metering insert is also shown as indicated by enlarged circle 410. Moreover, in an alternative embodiment, annular metering insert 126 is an annular ring 412 having a first surface 414 and opposite thereto a second surface 416, the second surface including a plurality of radial grooves 418. Moreover, in at least one embodiment the metering insert is a grooved insert 422. Grooved insert 422 is perhaps more fully appreciated with respect to the perspective view presented in FIG. 4A.

Returning to FIG. 4 and more specifically the enlarged view presented in circle 410, at least a portion of these grooves 418, e.g. the ridges defining the groves in second surface 412, seated against a portion of the primary body 104. In yet another embodiment, as opposed to, or in connection with the radial grooves 418, a plurality of radial passageways (not shown) are provided through the annular ring 412.

With respect to both embodiments shown in enlarged sections 402 and 410, it is understood and appreciated that the substantially circumferential liquid passage 122 is shown to be a partially undercut passage within primary body 104. At least one alternative embodiment exists for both the porous insert 400 and grooved insert 420, as shown in enlarged sections 422 and 424 respectively.

As shown in enlarged sections 422 and 424, in at least one alternative embodiment, porous insert 400′ and grooved insert 420′ each have a first diameter 426 and a second diameter 428 that is less than first diameter 426. This difference in thickness provides substantially circumferential liquid passage 122. Moreover, in at least one embodiment porous insert 400′ or grooved insert 420′ has a notch 430 that serves to define, at least in part, the substantially circumferential liquid passage 122.

As is apparent from the illustrations, this substantially circumferential liquid passage 122 is provided without undercutting primary body 104. It should also be understood and appreciated that although the notch is shown to be at the lower portion of each insert, in at least one alternative embodiment the notch is disposed between the bottom and top surfaces of the annular ring providing the metering insert 126.

With respect to the varying embodiments of annular metering insert 126, it is understood and appreciated that annular metering insert 126 is press fit into the primary body. Alternate means of joining metering insert 126 to primary body 104 so as to provide a fluid-tight seal and mechanical fastening may also be used. Such methods are well-known to those skilled in the art and include, without restriction, adhesive bonding, O-rings, welding, brazing, swaging, and similar methods or combinations of methods to retain and seal metering insert 126 to primary body 104. In addition, in at least one embodiment, annular metering insert 126 may be removed and replaced with a different annular metering insert so as to permit different flow characteristics such that atomizer 100 may be easily adapted for use with different liquids having different viscosities.

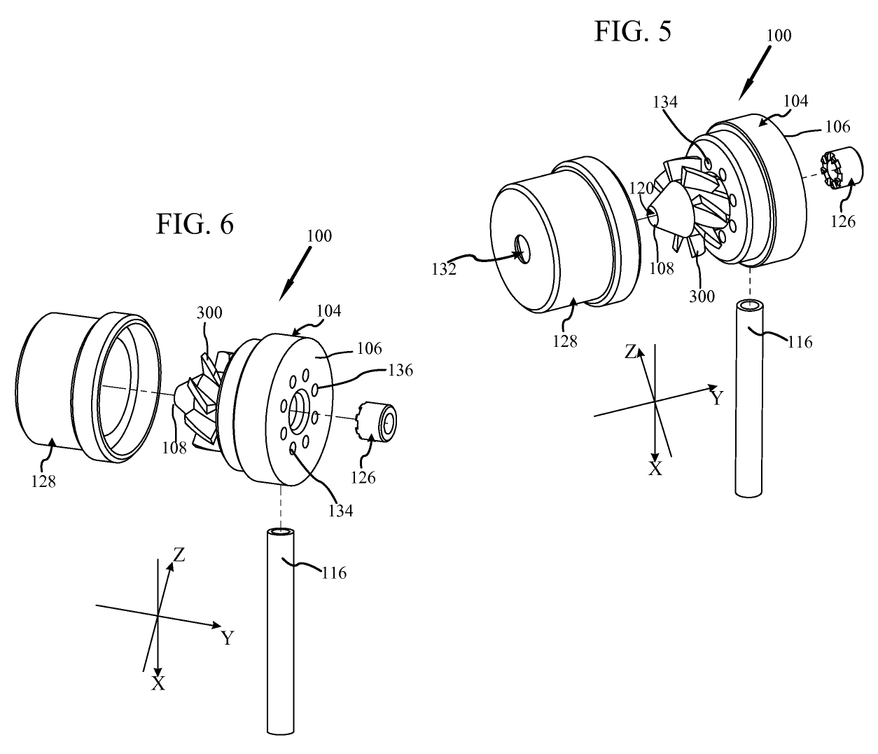

FIGS. 5 and 6 provide exploded views of atomizer 100 according to at least one embodiment, and more specifically the embodiment shown in FIGS. 2 and 3. Moreover it is appreciated that the vanes 300 are indeed affixed to primary body 104 and secondary body 128 is structured and arranged to receive the discharge end 108 of primary body 104. It is understood and appreciated that although metering insert 126 is illustrated as grooved insert 420, substitution of porous insert 400 (see FIG. 4) may be accomplished without departure from the disclosed invention.

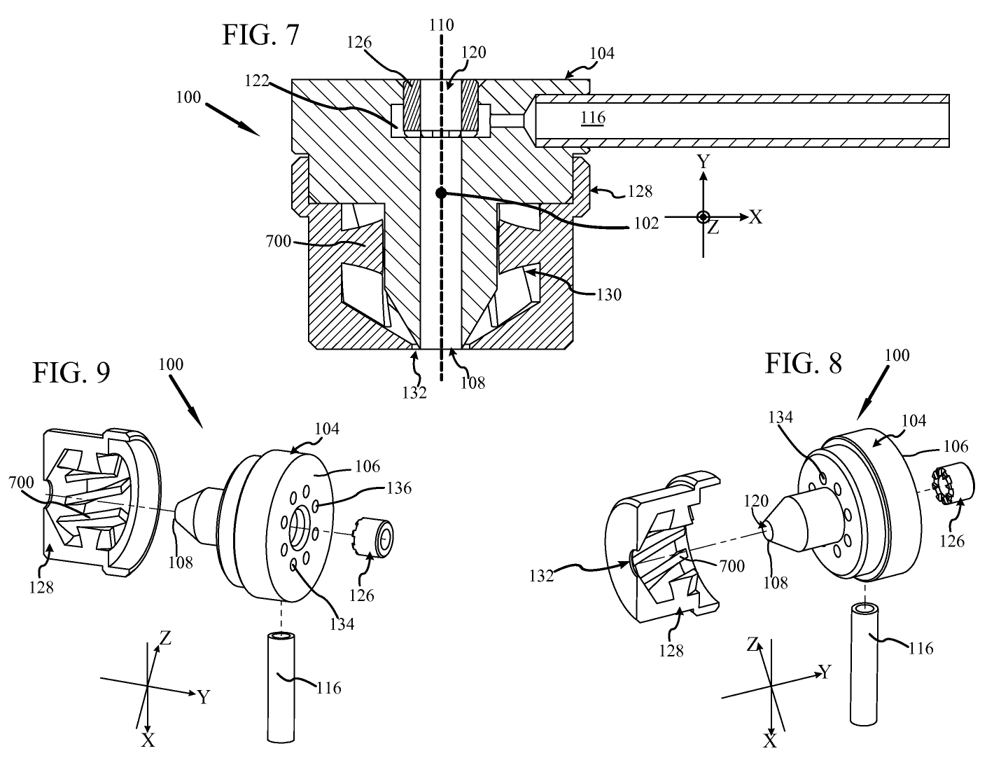

FIG. 7 provides a cross section view of an alternative embodiment wherein the swirling chamber 130 is provided by a structure of vanes 700 extending radially inward from the secondary body 128. Moreover, FIGS. 8 and 9 provide exploded and partial cutaway views to further illustrate the alternative embodiment of the swirling vanes 700 incorporated as part of the secondary body 128.

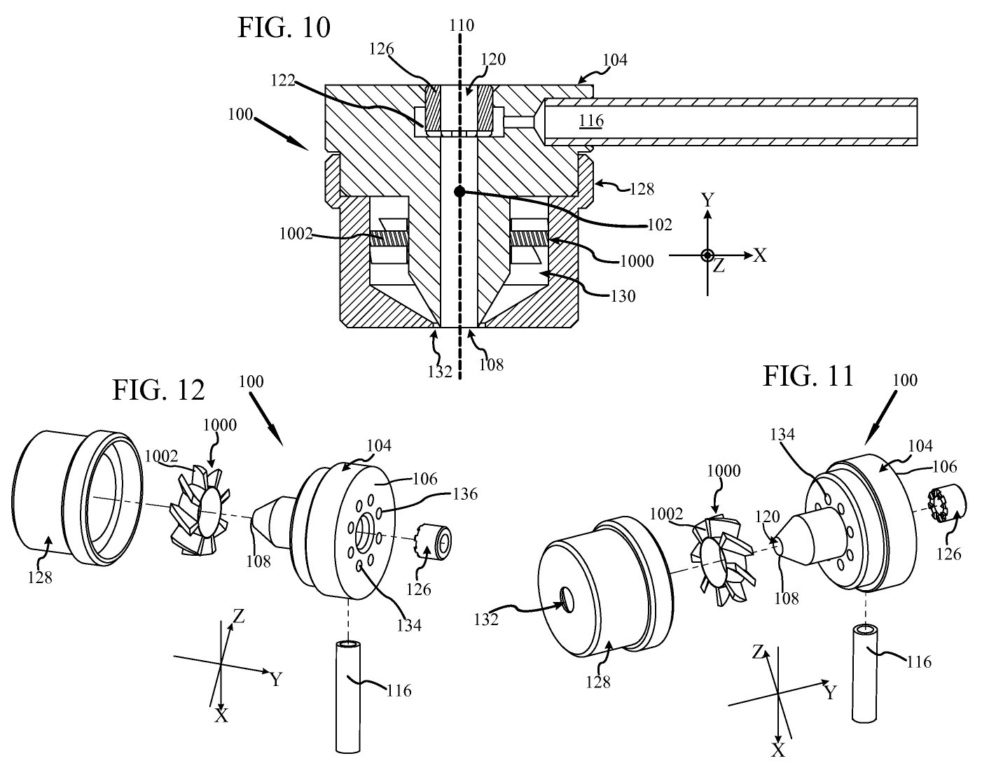

FIG. 10 similarly provides a cross section view of yet another alternative embodiment wherein the swirling chamber 130 is provided by a distinct structure of vanes as a swirling insert 1000 that is distinctly separate from both the primary body 104 and the secondary body 128. Moreover, FIGS. 11 and 12 provide exploded and partial cutaway views to further illustrate the alternative embodiment of the swirling insert 1000 disposed between the primary body 104 and the secondary body 128. As shown, in accordance with at least one embodiment swirling insert provides a plurality of vanes 1002 to define a plurality of swirling passageways.

With respect to FIGS. 1-10 as described above, atomizer 100 is understood and appreciated to be an atomizer design to flow 100% of the gas, e.g. primary gas and secondary gas, through the atomizer 100. In advantageous contrast to other atomizers known at the time of this disclosure filing, atomizer 100 is structured and arranged to utilize shear-driven flow of liquid driven by gas through the first gas passage 120 to achieve atomization. Indeed, an external pressure tank to pressurize the liquid beyond a natural, e.g. storage pressure, is not required.

FIG. 13 conceptually illustrates the operation of atomizer 100. Liquid, shown as beads 1300 for ease of illustration, is provided through liquid passage way 116 to substantially annular liquid reservoir 114, otherwise known in at least one embodiment as substantially circumferential liquid passage 122. Gas 1306, passing through primary gas passage 120 draws the liquid 1300 passing through the annular metering insert 126 into a thin film along the sidewall 1302 of primary gas passageway 130. The filming has been illustrated by deforming the beads 1300 from round to thin ovals 1304 during the progression along the sidewall 1302. Typical film thickness in at least one embodiment is within a range of about 10-50 μm.

More specifically, as shown in FIG. 13, as a gas passes through the first gas passage 120, the annular liquid flow from the metering insert 126 is formed into a thin annular sheet by shear forces with the primary gas 1306. In other words the first gas passage 120 is structured and arranged to provide shear-driven flow of liquid from the annular metering insert 126 to the discharge end 108.

With respect to FIG. 13 as well as FIGS. 1-3, 7 and 10, is understood and appreciated that the first gas passage 120 is structured and arranged to have a sufficient length to provide a thin annular flow of liquid from the metering insert 126 to the discharge end 108. Moreover, in at least one embodiment, in the event of a clog or disruption of the annular flow from annular metering insert 126, the length of the first gas passage 120 is sufficient to permit capillary forces of the liquid to reform a complete annular film within first gas passage 120. Indeed, with respect to at least one embodiment, the first gas passage 120 is structured and arranged to provide uniform prefilming of the fluid proximate to the discharge end 108 of the first gas passageway 120.

Secondary gas 1308 traveling through secondary gas inlets 134 is swirled in the swirling chamber and delivered to the opening 132 proximate to the discharge end 108. At the discharge end 108 the primary gas flow 1306 and the liquid flow 1304 meet the swirling secondary gas 1308, and the already thin liquid film is further stretched and thinned as the two gas streams meet. Due to the higher gas velocities and the differences in swirl components between the two gas streams, a highly turbulent zone just outside the discharge end 108 is produced and rapid liquid sheet breakup via a perforated sheet breakup mechanism begins proximate to the discharge end 108. This results in an atomized spray 1310.

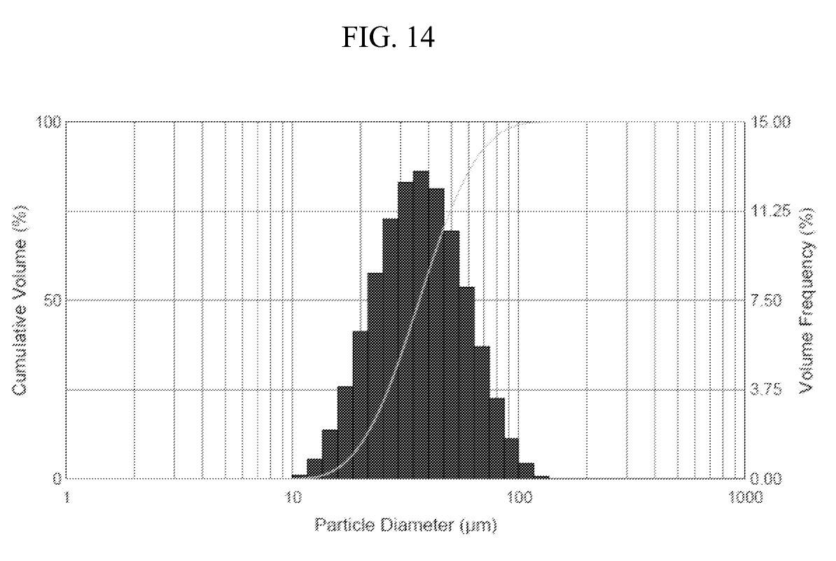

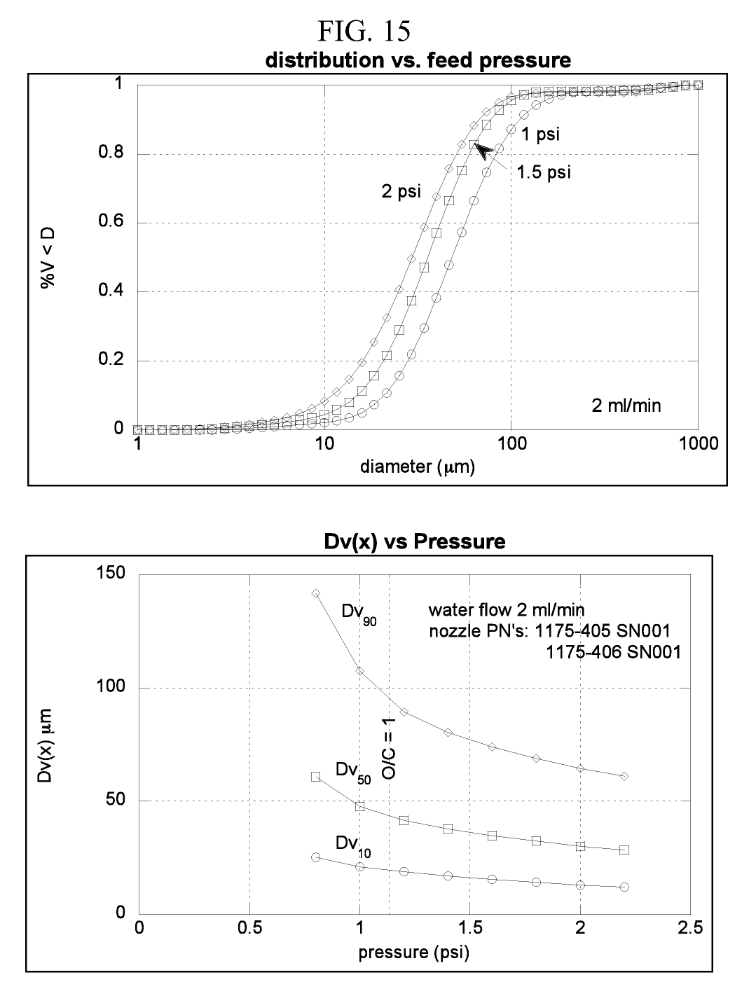

FIG. 14 shows a measured droplet distribution from atomizer 100 and illustrates that droplet size was less than 30 μm. Indeed, atomizer 100 can produce droples of this size at pressure differences as low as 2.5 kPa (10 inches of water), which is nearly an order of magnitude less than conventional air-blast atomizers. FIG. 15 presents graphs depicting the results from a Malvern Spraytex droplet size analyzer used to measure the droplets provided from LPA 100. As is shown, atomizer 100 is capable of producing volume mean droplet sizes under 30 μm with feed pressures lower than 10 kPa (1.5 psi).

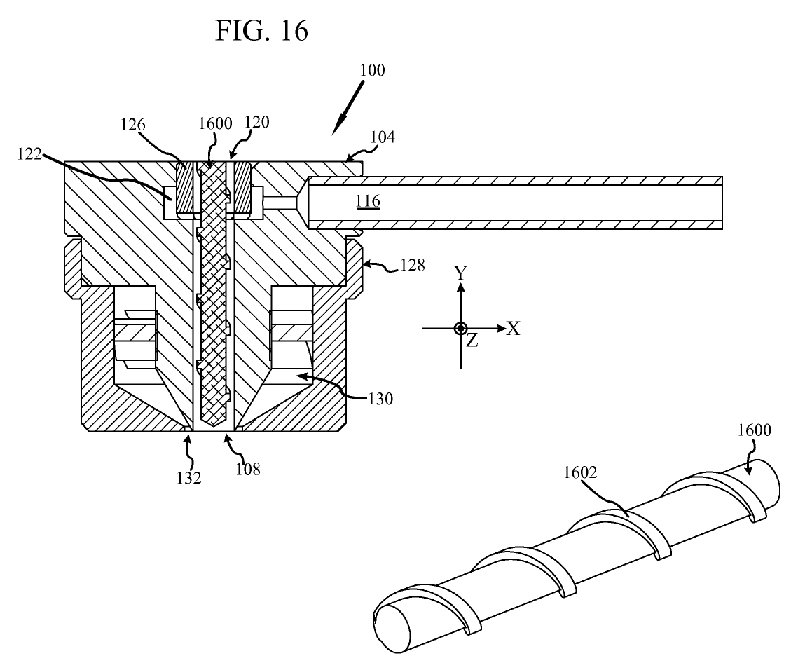

FIG. 16 illustrates a cross section view substantially the same as FIG. 2, with the addition of a member 1600 at least partially disposed within the first gas passage 120. The use of a member 1600 may increase the efficiency of the gas flow to induce the shear-driven flow of the liquid towards the discharge end 108. In further addition, in at least one embodiment, the member 1600 is a second swirler, structured and arranged to swirl gas within the first gas passage 120. In at least one embodiment this swirling of gas is facilitated by providing one or more swirling passages, for example by providing a raised corkscrew ridge 1602 about the length of member 1600. In at least one embodiment, the member 1600 is structured and arranged to swirl the gas in the first gas passage 112 in the same direction as gas swirled in the swirling chamber 130. In at least one alternative embodiment, the member 1600 is structured and arranged to swirl the gas in the first gas passage 120 in the opposite direction as gas swirled in the swirling chamber 130.

A significant and unique advantage of atomizer 100 is that only large passage sizes for the gas and liquid are used. More specifically the exit diameter of the discharge end 108 of the first gas passage 120 is about several millimeters, rather than tens of micrometers as in a typical traditional pressure atomizer. The large flow dimensions for the gas and liquid advantageously reduce the potential for clogging due to build up of tars and or other debris as may be found in various gasses and liquids.

While the invention has been described with reference to the preferred embodiment, it will be understood by those skilled in the art that various alterations, changes and improvements may be made and equivalents may be substituted for the elements thereof and steps thereof without departing from the scope of the present invention. Further, in the above description of various embodiments, relative terms such as top, bottom, upper, lower, etc. . . . have been used for ease of description and illustration and are understood not to be terms of limitation. In addition, many modifications may be made to adapt to a particular situation or material to the teachings of the invention without departing from the essential scope thereof. Such alterations, changes, modifications, and improvements, though not expressly described above, are nevertheless intended and implied to be within the scope and spirit of the invention. Therefore, it is intended that the invention not be limited to the particular embodiments disclosed as the best mode contemplated for carrying out this invention, but that the invention will include all embodiments falling within the scope of the appended claims.

What is claimed is:

1. A low pressure air-blast atomizer, comprising:
a primary body having an inlet side, a discharge end and an axis therebetween;
an annular prefilmer disposed about the axis;
a substantially annular liquid reservoir about the annular prefilmer and proximate to the inlet side;
a liquid passageway structured and arranged to provide liquid from an external source to the liquid reservoir;
a liquid meterer structured and arranged to circumferentially meter liquid from the liquid reservoir to the annular prefilmer;
a secondary body structured and arranged to receive the discharge end, the secondary body and discharge end defining a swirling chamber about at least a portion of the annular prefilmer, the swirling chamber opening proximate to the discharge end; and
a plurality of secondary gas passages extending from the swirling chamber to external ports proximate to the inlet side.

2. The low pressure air-blast atomizer of claim 1, wherein liquid meterer is a porous annular insert.

3. The low pressure air-blast atomizer of claim 1, wherein liquid meterer is a annular ring having a top and bottom surface, the bottom surface including a plurality of radial grooves, the bottom surface seated against at least a part of the annular prefilmer.

4. The low pressure air-blast atomizer of claim 1, wherein the annular prefilmer is structured and arranged to provide a shear-driven flow of liquid from the metering insert to the discharge end.

5. The low pressure air-blast atomizer of claim 1, wherein a member is at least partially disposed within the annular prefilmer.

6. The low pressure air-blast atomizer of claim 1, wherein the member is a second swirler, structured and arranged to swirl gas within the annular prefilmer.

7. A low pressure air-blast atomizer, comprising:
a primary body having an inlet side, a discharge end and an axis therebetween;
a first gas passage disposed about the axis;
a substantially circumferential liquid passage adjacent to the first gas passage and proximate to the inlet side;
an annular metering insert disposed between the circumferential liquid passage and the first gas passage, the metering insert providing substantially circumferential fluid communication between the circumferential liquid passage and the first gas passage;
a liquid inlet passageway extending from the circumferential liquid passage to an external liquid port;
a secondary body structured and arranged to receive the discharge end, the secondary body and discharge end defining a plurality of swirling passageways circumferentially about the first gas passage and terminating proximate to a discharge end of the first gas passage; and
a plurality of secondary gas passages extending from the swirling passageways to external ports proximate to the inlet side.

8. The low pressure air-blast atomizer of claim 7, wherein the annular metering insert is a porous insert.

9. The low pressure air-blast atomizer of claim 7, wherein the annular metering insert is an annular ring having a first surface and opposite thereto a second surface, the second surface including a plurality of radial grooves, the bottom surface seated against at least a part of the first gas passage.

10. The low pressure air-blast atomizer of claim 7, wherein the annular metering insert has a substantially circumferential notch, the circumferential notch structured and arranged to provide at least part of the substantially circumferential liquid passage.

11. The low pressure air-blast atomizer of claim 7, wherein the first gas passage is structured and arranged to provide a thin annular flow of liquid from the metering insert to the discharge end.

12. The low pressure air-blast atomizer of claim 7, wherein the first gas passage is a continuous passage along the axis throughout the primary body.

13. The low pressure air-blast atomizer of claim 7, wherein the first gas passage is structured and arranged to provide uniform prefilming of the fluid proximate to the discharge end of the first gas passage.

14. The low pressure air-blast atomizer of claim 7, wherein a member is at least partially disposed within the first gas passage.

15. The low pressure air-blast atomizer of claim 14, wherein the member is a second swirler, structured and arranged to swirl gas within the first gas passage.

16. The low pressure air-blast atomizer of claim 15, wherein the second swirler is structured and arranged to swirl gas in the same direction as the plurality of swirling passageways.

17. The low pressure air-blast atomizer of claim 15, wherein the second swirler is structured and arranged to swirl gas in the opposite direction as the plurality of swirling passageways.

18. A low pressure air-blast atomizer, comprising:
a primary body having;
an inlet side;
a tapered discharge end and an axis therebetween;
a primary gas passage disposed about the axis;
a plurality of secondary gas passages about and apart from the primary gas passage in the inlet end;
a substantially annular channel proximate to the primary gas passage and adjacent to the inlet end;
a liquid passage adjoining the substantially annular channel to an external liquid port disposed in the inlet end; and
an annular metering insert disposed in the primary gas passage adjacent to the substantially annular channel, the annular metering insert providing substantially circumferential fluid communication between the substantially annular channel and the primary gas passage;
a secondary body structured and arranged to receive the tapered discharge end;
at least one swirling structure disposed between the secondary body and the tapered discharge end to define a swirling chamber, the swirling chamber having an input section in communication with the secondary gas passages and an output section adjacent to a discharge end of the primary gas passage.

19. The low pressure air-blast atomizer of claim 18, wherein a plurality of vanes extending radially outward from the tapered discharge end are structured and arranged as the swirling structure.

20. The low pressure air-blast atomizer of claim 18, wherein a plurality of vanes extending radially inward from the secondary body are structured and arranged as the swirling structure.

21. The low pressure air-blast atomizer of claim 18, wherein the annular metering insert is a porous insert.

22. The low pressure air-blast atomizer of claim 18, wherein the annular metering insert is an annular ring having a top and bottom surface, the bottom surface including a plurality of radial grooves, the bottom surface seated against at least a part of the primary gas passage.

23. The low pressure air-blast atomizer of claim 18, wherein the annular metering insert has a substantially circumferential notch, the circumferential notch structured and arranged to provide at least part of the substantially annular channel passage.

24. The low pressure air-blast atomizer of claim 18, wherein the primary gas passage is structured and arranged to provide a shear-driven flow of liquid from the annular metering insert to the discharge end.

25. The low pressure air-blast atomizer of claim 18, wherein the primary gas passage is structured and arranged to provide uniform prefilming of the fluid proximate to the discharge end of the primary gas passage.

26. The low pressure air-blast atomizer of claim 18, wherein the primary gas passage is a continuous passage along the axis throughout the primary body.

27. The low pressure air-blast atomizer of claim 18, wherein a member is at least partially disposed within the primary gas passage.

28. The low pressure air-blast atomizer of claim 27, wherein the member is a second swirler, structured and arranged to swirl gas within the primary gas passage.

29. The low pressure air-blast atomizer of claim 28, wherein the second swirler is structured and arranged to swirl gas in the same direction as the swirling chamber.

30. The low pressure air-blast atomizer of claim 28, wherein the second swirler is structured and arranged to swirl gas in the opposite direction as the swirling chamber.
